(19) United States
(12) Patent Application Publication
(10) Pub. No.: US 2018/0285977 A1
(43) Pub. Date: Oct. 4, 2018

(54) SYSTEMS AND METHODS FOR MULTI-PARTY SENSORS

(71) Applicant: The Travelers Indemnity Company, Hartford, CT (US)

(72) Inventors: Corey T. Cleary, Chicago, IL (US); Kristin Shumway, West Hartford, CT (US); Michael Commendatore, Southington, CT (US); Richard I. Reilly, East Windsor, CT (US); Sean T. Datcher, Weatogue, CT (US)

(21) Appl. No.: 15/473,583

(22) Filed: Mar. 29, 2017

(51) Int. Cl. G06Q 40/08; H04W 4/00; H04L 29/06; H04W 12/04; H04W 12/06

(52) U.S. Cl. CPC G06Q 40/08; H04W 4/003; H04L 63/06; H04W 88/02; H04W 12/04; H04W 12/06; H04L 67/42; H04L 63/08

(57) ABSTRACT

Systems, methods, and articles of manufacture provide for multi-party sensors managed via a mobile device application that coordinates first-party data, thresholds, and alerts from a first-party server and second-party data, thresholds, and alerts from a second-party server.

### BACKGROUND

Internet-enabled sensors have seen increasing adoption in the marketplace, particularly due to the prevalence of Internet-enabled mobile electronic devices, such as smart phones. Many consumers own a smart phone and are accordingly able to interface with Internet-enabled sensor devices without the need to purchase additional equipment (e.g., specialized routers, computers, or a home security system). Consumer hand-held devices are now able, for example, to interface with “smart” thermostats, “smart” doorbells, security sensors, and even “smart” appliances like refrigerators. These Internet-connected “smart” devices, however, are predominantly proprietary and limited to specific functionality.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block diagram of a system according to some embodiments;

FIG. 3 is a flow diagram of a method according to some embodiments;

FIG. 4A, FIG. 4B, FIG. 4C, and FIG. 4D are diagrams of an interface according to some embodiments;

FIG. 5 is a block diagram of an apparatus according to some embodiments; and

FIG. 6A, FIG. 6B, FIG. 6C, FIG. 6D, and FIG. 6E are perspective diagrams of exemplary data storage devices according to some embodiments.

### DETAILED DESCRIPTION

### I. Introduction

Internet-connected devices, such as Internet-enabled sensors, are typically operative to interface with a remote device application that is configured to relay data to a particular central server. The manufacturer of the sensor may, for example, operate the central server and provide the mobile device application so that users can interface with both the sensor and the central server. In such a manner, the user may obtain sensor readings from the sensor (via the mobile device application) and have access to proprietary data processing logic and/or functionality provided by the server.

Often, such functionality is adequate and provides a desirable advantage to a consumer. The consumer may interface with home security sensors, check or adjust their thermostat, or communicate with someone at their door (e.g., remotely). In certain cases, however, it may be desirable for Internet-enabled sensors to be utilized as cross-industry platforms that provide multiple and/or integrated advantages. Typical sensors are limited to single-party or single-server communications, however, and are accordingly not capable of providing cross-industry advantages. While a user may be provided with a temperature reading in a room, for example, the typical sensor and associated system architecture would merely allow the user to send commands to a thermostat (e.g., to change the temperature). Should the temperature be relevant to other industries (e.g., other than HVAC controls), such as home insurance, fire prevention, regulatory, or sustainability, however, the sensor and associated system environment are inadequate to provide a cross-industry platform that provides additional functionality.

In accordance with embodiments herein, these and other deficiencies of previous efforts are remedied, such as by providing systems, apparatus, methods, and articles of manufacture for multi-party sensors. In some embodiments for example, a sensor may be configured to communicate with (e.g., pair with) a mobile electronic device of a user that executes a mobile device application to activate and/or control the sensor. The activation and/or control may comprise, for example, communication with a first server (e.g., operated by a first entity), such as providing first account credentials and/or an identifier of the sensor. The first server may, in some embodiments, store data operable to cause an alert to be provided to the mobile device application in the case that a reading from the sensor exceeds a predetermined threshold. In some embodiments, the mobile device application may initiate communication with a second server (e.g., operated by a second entity), such as by providing second account credentials and/or the identifier of the sensor. According to some embodiments, the first and second servers may communicate to effectuate an analysis, by the second server, of one or more sensor readings. In some embodiments, the second server may provide an incentive or award based on the analysis of the sensor reading.

### II. Multi-Party Sensor Systems

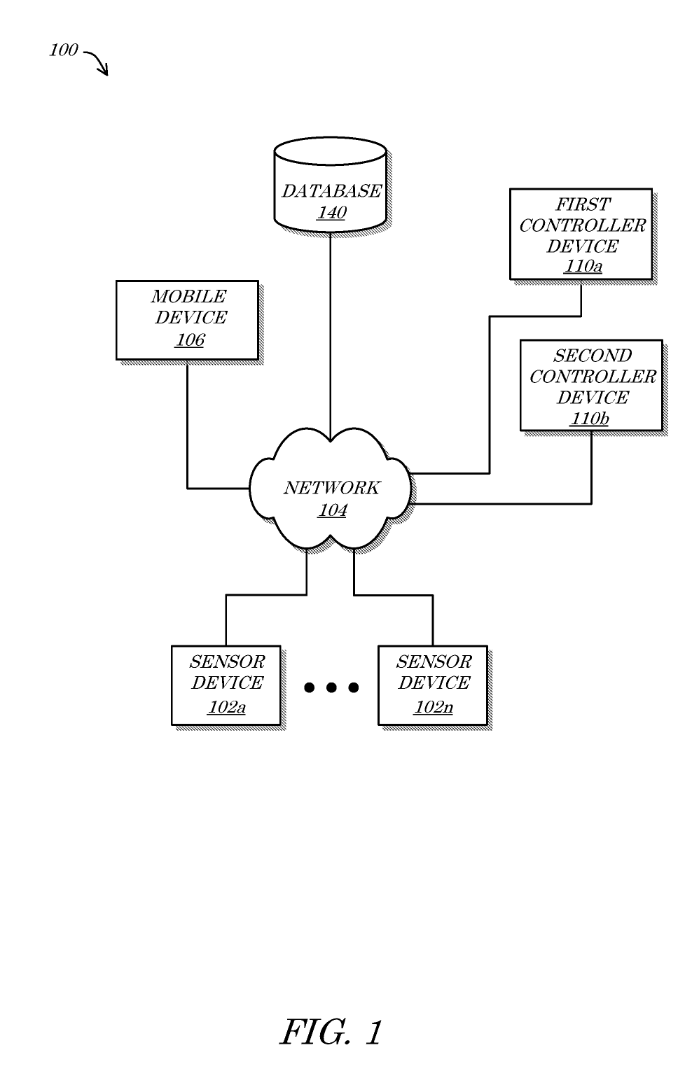

Referring first to FIG. 1, a block diagram of a system 100 according to some embodiments is shown. In some embodiments, the system 100 may comprise a multi-party sensor system that is operable to provide enhanced multi-industry functionality to an end-user. The system 100 may comprise, for example, a plurality of sensor devices 102a-n (e.g., coupled to and/or disposed in a particular structure, such as a home, business, and/or commercial building), a network 104, a mobile device 106 (e.g., a mobile electronic device owned and/or operated by a user), a first controller device 110a, and/or a second controller device 110b, and/or a database 140. As depicted in FIG. 1, any or all of the devices 102a-n, 106, 110a-b, 140 (or any combinations thereof) may be in communication via the network 104. In some embodiments, the system 100 may be utilized to provide (and/or receive) sensor data, alert data, insurance data, incentive and/or award data, and/or other data or metrics. The first controller device 110a may, for example, interface with one or more of the sensor devices 102a-n, the database 140, and/or the mobile device 106 to provide sensor reading data and/or first party-based alerts (e.g., first alerts). In some embodiments, the second controller device 110b may interface with one or more of the sensor devices 102a-n, the first controller device 110a, the database 140, and/or the mobile device 106 to provide incentives, awards, and/or second party-based alerts (e.g., second alerts).

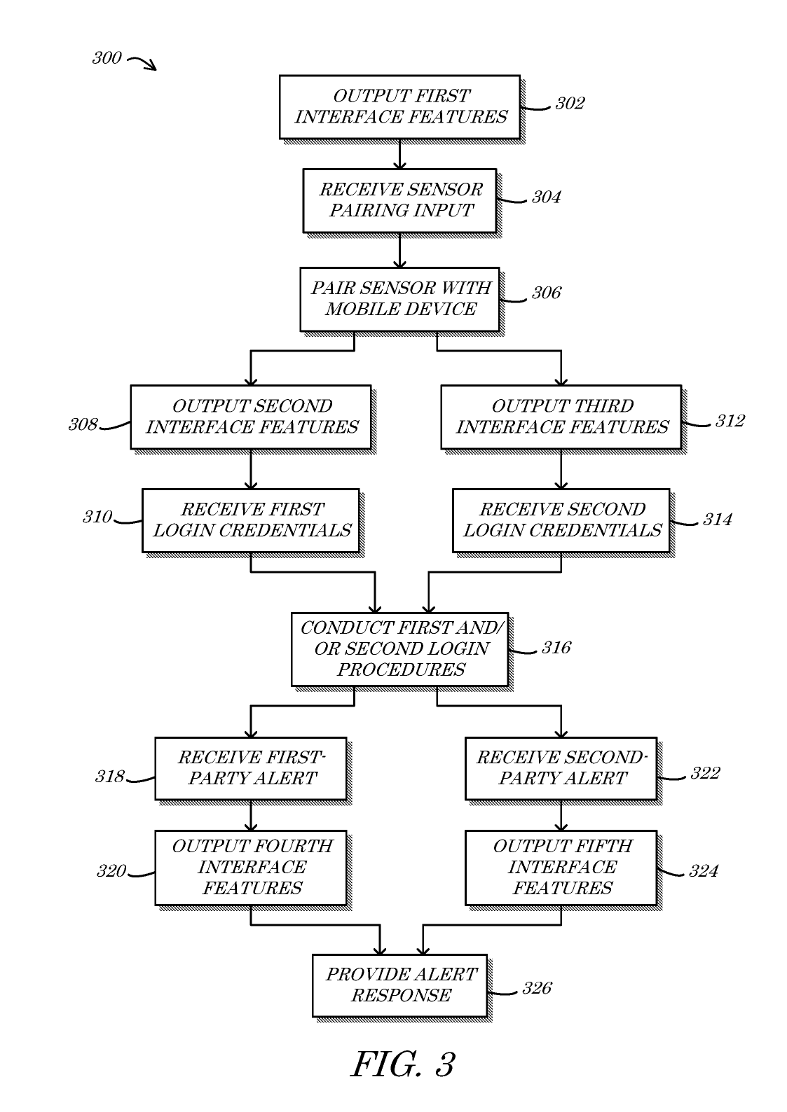

Fewer or more components 102a-n, 104, 106, 110a-b, 140 and/or various configurations of the depicted components 102a-n, 104, 106, 110a-b, 140 may be included in the system 100 without deviating from the scope of embodiments described herein. In some embodiments, the components 102a-n, 104, 106, 110a-b, 140 may be similar in configuration and/or functionality to similarly named and/or numbered components as described herein. In some embodiments, the system 100 (and/or portion thereof) may comprise a risk assessment and/or underwriting or sales program, system, and/or platform programmed and/or otherwise configured to execute, conduct, and/or facilitate the method 300 of FIG. 3 herein, and/or portions thereof.

In some embodiments, the sensor devices 102a-n may comprise one or more sensors configured, disposed, and/or coupled to sense, measure, calculate, and/or otherwise process or determine data, such as temperature, humidity, pressure, location (e.g., coordinates and/or distance), speed, acceleration, flow, voltage, amperage, resistance, motion, light level, etc. In some embodiments, such sensor data may be provided to the first controller device 110a (e.g., via the network 104), such as to analyze and/or process the sensor data (e.g., readings and/or measurements) with respect to one or more thresholds (such as the first thresholds described herein). The sensor devices 102a-n may comprise, but are not limited to, for example, any number, type, and/or configuration of pressure sensors, flow meters, light sensors, strain sensors, humidity sensors, temperature sensors, mass sensors, volumetric sensors, motion sensors, and/or voltage, amperage, and/or resistance sensors that are or become known or practicable. As described herein, each sensor 102a-n may be disposed to measure or read a particular variable value for a particular area in which the sensor is disposed, coupled, and/or mounted. A first sensor 102a may, for example, comprise a temperature sensor installed in a first room of a building and/or the n^{th} sensor 102n may comprise a glass break sensor (e.g., a security sensor) located in a second room of the building.

In some embodiments, the sensor devices 102a-n may interface with the first controller device 110a and/or the mobile device 106 to effectuate communications (direct or indirect) with one or more other sensor devices 102a-n (such communication not explicitly shown in FIG. 1). In some embodiments, the sensor devices 102a-n may interface with the first controller device 110a to effectuate communications (direct or indirect) with the mobile device 106 and/or the second controller device 110b (such communication also not explicitly shown in FIG. 1). In some embodiments, sensor data may be provided to the first controller device 110a and/or the second controller device 110b, such as to manage a first set of thresholds and alerts, manage a second set of thresholds and alerts, provide incentives, awards, and/or conduct an electronic game (e.g., utilizing sensor data as described herein).

The network 104 may, according to some embodiments, comprise a Local Area Network (LAN; wireless and/or wired), cellular telephone, Bluetooth®, Near Field Communication (NFC), and/or Radio Frequency (RF) network with communication links between the controller devices 110a-b, the sensor devices 102a-n, the mobile device 106, and/or the database 140. In some embodiments, the network 104 may comprise direct communications links between any or all of the components 102a-n, 106, 110a-b, 140 of the system 100. The sensor devices 102a-n may, for example, be directly interfaced or connected to one or more of the controller devices 110a-b and/or the mobile device 106 via one or more wires, cables, wireless links, and/or other network components, such network components (e.g., communication links) comprising portions of the network 104. In some embodiments, the network 104 may comprise one or many other links or network components other than those depicted in FIG. 1. The sensor devices 102a-n may, for example, be connected to the first controller device 110a via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110a-b, 140 of the system 100. The network 104 may comprise one or more cellular telephone networks with communication links between the mobile device 106 and the second controller device 110b, for example, and/or may comprise the Internet, with communication links between the first controller device 110a, the second controller device 110b, the mobile device 106, and/or the database 140, for example.

The mobile device 106, in some embodiments, may comprise any type or configuration of computing, hand-held electronic, network, user, and/or communication device that is or become known or practicable. The mobile device 106 may, for example, comprise one or more laptop or tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the mobile device 106 may comprise a device owned and/or operated by one or more users such as a consumer or customer (or potential customer). According to some embodiments, the mobile device 106 may communicate with each of the controller devices 110a-b via the network 104, such as to (i) pair or register a sensor 102a-n, (ii) login to the first controller 110a (e.g., utilizing first credentials), (iii) login to the second controller 110b (e.g., utilizing second credentials), (iv) receive a first alert from the first controller 110a, based on an exceeding of a sensor reading of a first threshold, (v) receive a second alert from the second controller 110b, based on an exceeding of a sensor reading of a second threshold, (vi) receive an incentive from the second controller 110b, and/or (vii) participate in an online electronic game based on at least one sensor reading, as described herein.

In some embodiments, the controller devices 110a-b may comprise electronic and/or computerized controller devices such as a computer server communicatively coupled to interface with the sensor devices 102a-n and/or the mobile device 106 (directly and/or indirectly). The controller devices 110a-b may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller devices 110a-b may be located remote from one or more of the sensor devices 102a-n and/or the mobile device 106. The controller devices 110a-b may also or alternatively comprise a plurality of electronic processing devices located at one or more various sites and/or locations.

According to some embodiments, each controller device 110a-b may store and/or execute specially programmed instructions to operate in accordance with embodiments described herein. The controller devices 110a-b may, for example, execute one or more programs that use sensor readings and/or user data to define and/or trigger alerts and/or provide incentives, awards, and/or game outcomes or results. According to some embodiments, either or both of the controller devices 110a-b may comprise a computerized processing device such as a PC, laptop computer, computer server, and/or other electronic device to manage and/or facilitate transactions and/or communications regarding the sensor devices 102a-n and/or the mobile device 106. A user (e.g., customer, consumer, client, or company) may, for example, utilize the first controller device 110a to manage communications with a sensor device 102a-n and/or may utilize the second controller device 110b to receive incentives and/or awards (e.g., electronic game awards) based on sensor readings (e.g., in accordance with embodiments described herein).

In some embodiments, the controller devices 110a-b and/or the mobile device 106 (and/or the sensor devices 102a-n) may be in communication with the database 140. The database 140 may store, for example, sensor data obtained from the sensor devices 102a-n, threshold and/or alert data defined by the controller devices 110a-b, and/or instructions that cause various devices (e.g., the controller devices 110a-b, the mobile device 106, and/or the sensor devices 102a-n) to operate in accordance with embodiments described herein. In some embodiments, the database 140 may comprise any type, configuration, and/or quantity of data storage devices that are or become known or practicable. The database 140 may, for example, comprise an array of optical and/or solid-state hard drives configured to store sensor data provided by (and/or requested by) the sensor devices 102a-n, threshold data, alert data, user data, insurance data, incentive data, game data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the sensor devices 102a-n or mobile device 106 may comprise the database 140 or a portion thereof, for example, and/or one or more of the controller devices 110a-b may comprise the database or a portion thereof.

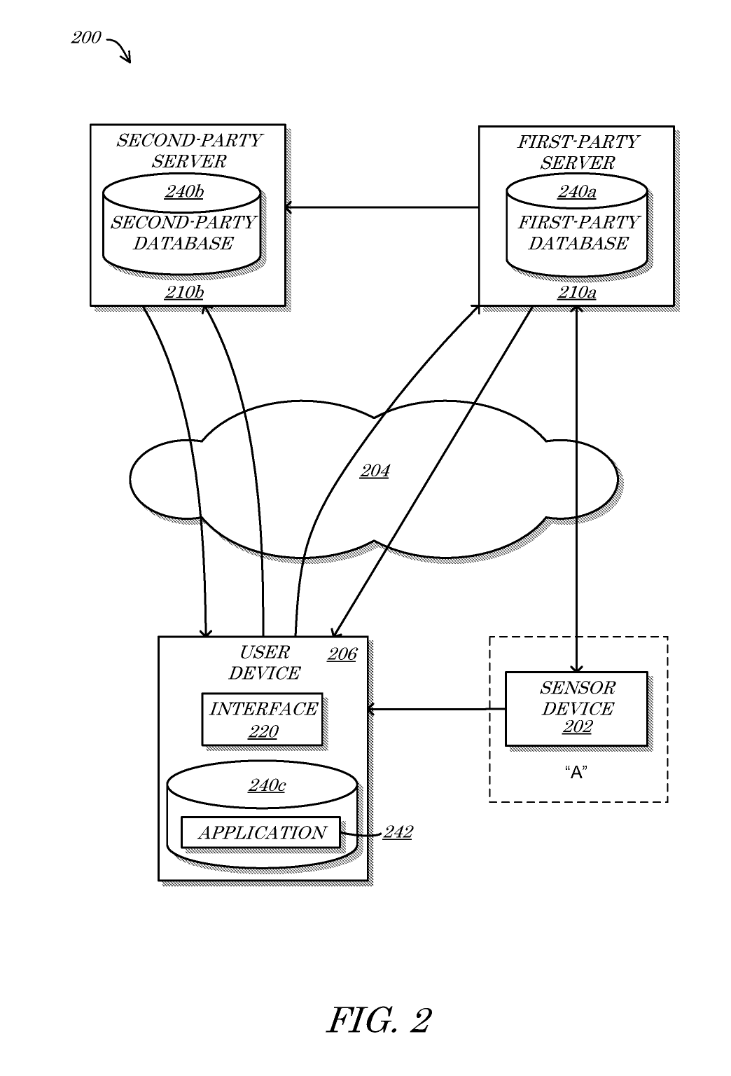

Turning now to FIG. 2, a block diagram of a system 200 according to some embodiments is shown. In some embodiments, the system 200 may comprise a multi-party sensor analysis and management system similar to the system 100 of FIG. 1. The system 200 may comprise, for example, a sensor device 202 disposed at, in, or on a particular structure (or object) “A”. In some embodiments, the sensor device 202 may sense and/or record data from one or more specific locations in the structure “A” (not separately depicted in FIG. 2). The sensor 202 may measure, record, and/or monitor, for example, motion in a room, a temperature of a freezer or a pipe, and/or a location of a construction vehicle (e.g., in the case the structure or object “A” comprises a building, warehouse, and/or construction machinery, respectively).

According to some embodiments, the sensor 202 may be configured to communicate (e.g., via a network 204) with a user device 206 and/or one or more servers 210a-b. The sensor may be communicatively coupled, via the network 204, with a first or first-party server 210a, for example, such as to provide sensor data (e.g., readings and/or a sensor identifier) thereto. In some embodiments, the sensor 202 may provide sensor data directly to the user device 206 and/or may otherwise be directly (e.g., via wired and/or short-range wireless communications) communicatively coupled to the user device 206. The sensor device 202 may, for example, interface directly with the user device 206 to effectuate the communicative coupling, initialization, and/or pairing of the sensor device 202 and the user device 206. The user device 206 may, in some embodiments, comprise and/or generate an interface 220 via which communication with the sensor 202 (and/or with the servers 210a-b) may be effectuated and/or managed.

In some embodiments, any or all of the electronic devices 202, 206, 210a-b may be in communication with and/or communicatively coupled to one or more memory devices 240a-c. The first-party server 201a may comprise and/or be communicatively coupled to, for example, a first or first-party database 240a and/or a second or second-party server 210b may comprise and/or be communicatively coupled to a second or second-party database 240b. In some embodiments, the user device 206 may comprise a local memory 240c that stores, for example, a multi-party sensor application 242.

According to some embodiments, the user device 206 may execute the multi-party sensor application 242 to generate the interface 220 and/or to communicate with the sensor 202. The multi-party sensor application 242 may, for example, store specially-coded instructions that cause the user device 206 to initiate and/or conduct a pairing sequence or procedure that communicatively links the sensor 202 and the user device 206. In the case that the sensor 202 comprises an “Internet of Things (IoT)”-enabled processing device with Wi-Fi®, Bluetooth®, Near-Field Communication (NFC) and/or other short-range wireless communication capabilities and/or embedded protocols, for example, the multi-party sensor application 242 may initiate a short-range wireless communication pairing procedure that utilizes information broadcast (e.g., short-range broadcast) by the sensor 202 (e.g., such as an identifier and/or pairing code). In some embodiments, the sensor 202 may provide a sensor identifier to the user device 206. The sensor 202 may, in some embodiments, transmit the sensor identifier and/or other sensor data (e.g., a sensor reading) to the first-party server 210a.

In such a manner, for example, in the case that the user device 206 communicates with the first-party server 210a, the first-party server 210a may identify (and/or establish) a relationship between the user device 206 (and/or a user and/or account associated therewith) and the sensor 202. The user device 206 may, by execution of the multi-party sensor application 242, for example, initiate a first login procedure with the first-party server 210a. The first login procedure may, in some embodiments, comprise a transmission, by the user device 206 and to the first-party server 210a, of the sensor identifier and a user identifier (e.g., a user name, account number, etc.). The user device 206 may be utilized, for example, to supply first login credentials and the sensor identifier to the first-party server 210a. The first-party server 210a may, in some embodiments, store the first login credentials and/or the sensor identifier (e.g., in relation to one another) in the first-party database 240a. In such a manner, for example, upon receiving the first login credentials from the user device 206, the first-party server 210a may authenticate the first login credentials and/or match the provided sensor identifier with sensor identification information stored in the first-party database 240a. In some embodiments, the first login procedure may be effectuated via the interface 220 (e.g., that may be generated by execution of the multi-party sensor application 242).

According to some embodiments, once the first login procedure is complete, the user device 206 may communicate with the sensor 202 and/or the first-party server 210a to retrieve and/or obtain sensor readings and/or other sensor data. The interface 220 may be utilized, for example, to ping or query the sensor 202 (e.g., directly) and/or the first-party database 240a to obtain and output (via the user device 206) indications of sensor settings, preferences, and/or measured data or readings. In some embodiments, the first-party database 240a may store one or more first-party thresholds with respect to sensor data and/or readings. The interface 220 may be utilized, for example, to establish and/or edit a first-party threshold in accordance with user preferences. In the case that a first-party threshold is defined by a user as a temperature of thirty-two degrees Fahrenheit (32° F. or 0° C.; i.e., the freezing point of water), for example, and a sensor reading from the sensor 202 is identified as being below the first-party threshold, a first-party alert may be triggered. The first-party server 210a may be operative to execute specially-coded instructions stored in the first-party database 240a, for example, to identify the first-party alert condition (as defined by a comparison of the sensor reading with the first-party threshold) and transmit an indication of the alert to the user device 206. In some embodiments, the first login procedure may comprise a provision of an electronic communications address and/or machine identifier of the user device 206 to the first-party server 210a. Such electronic communications address may be stored in the first-party database 240a and utilized by the first-party server 210a to transmit the indication of the first-party alert.

In some embodiments, the first-party alert, sensor data (such as the sensor identifier and/or sensor readings), and/or user/account identification information may be provided by the first-party server 210a to the second-party server 210b. According to some embodiments, the user device 206 may communicate (e.g., via execution of the multi-party sensor application 242) with the second-party server 210b. In such a manner, for example, the second-party server 210b may identify (and/or establish) a relationship between the user device 206 (and/or a user and/or account associated therewith) and the sensor 202. The user device 206 may, by execution of the multi-party sensor application 242 for example, initiate a second login procedure with the second-party server 210b. The second login procedure may, in some embodiments, comprise a transmission, by the user device 206 and to the second-party server 210b, of the sensor identifier and/or a user identifier (e.g., a user name, account number, etc.). The user device 206 may be utilized, for example, to supply second login credentials and/or the sensor identifier to the second-party server 210b. The second-party server 210b may, in some embodiments, store the second login credentials and/or the sensor identifier (e.g., in relation to one another) in the second-party database 240b. In such a manner, for example, upon receiving the second login credentials from the user device 206, the second-party server 210b may authenticate the second login credentials and/or match the provided sensor identifier with sensor identification information stored in the second-party database 240b. In some embodiments, the second login procedure may be effectuated via the interface 220 (e.g., that may be generated by execution of the multi-party sensor application 242). In some embodiments, the first and second login credentials may be the same or execution of the multi-party sensor application 242 may require login credentials (e.g., third login credentials—or first login credentials, with the other login credentials being described as second and third login credentials) that query the local memory 240c to retrieve a stored indication of the first and second login credentials.

According to some embodiments, the second-party database 240b may store additional information relative to a second party (not shown). While the first-party server 210a and the first-party database 240a may be owned, operated by, and/or relative to a first industry and/or first party (not shown), such as a home security services provider in the home security industry, for example, the second-party server 210b and the second-party database 240b may be owned, operated by, and/or relative to the second party, such as an insurance provider in the home insurance industry. In the non-limiting example of the second party being an insurance provider, the second-party database 240b may store (e.g., in relation to the user identifier and/or second login credentials) insurance-related information, such as insurance policy limits, premium and/or deductible amounts, discounts, price increases or penalties, policy effective and/or termination dates, policy limitations (e.g., geographic limitations on coverage or insured-object location), insurance-related thresholds and/or alert criteria, insurance-related user preferences, information descriptive of insurance claims, etc. (e.g., second-party data).

In some embodiments, such second-party data may be provided to the user device 206 from the second-party server 210b. According to some embodiments, second-party data may be provided to the user device 206 in response to a receipt, by the second-party server 210b, of first-party alert and/or sensor data (e.g., transmitted by the first-party server 210a). In response to an identification of a first-party alert, for example, the second-party server 210b may trigger a second-party alert and/or identify data to send to the user device 206. In some embodiments, the first-party and second-party alerts may be different. While the first-party alert may be relevant to the first-party industry and be descriptive of, e.g., a temperature reading that is out of acceptable range, for example, the second-party alert may be relevant to the second-party industry. In the non-limiting example of a second-party insurance industry, for example, the second-party alert may comprise an indication that (e.g., based on the first-party alert and/or the sensor reading) an insurance parameter has changed. In the case that the temperature reading is out of an acceptable range and causes the first-party alert, for example, the second-party alert may comprise an indication that an insurance premium has (or will or may be) increased or may comprise an indication of a required action to prevent adverse insurance policy effects (e.g., remedy the temperature situation within twelve (12) hours, otherwise a homeowners insurance premium may increase by a certain percentage or dollar amount). According to some embodiments, the interface 220 may be utilized to set, view, and/or adjust any second-party thresholds, e.g., stored in the second-party database 240b. The user device 206 may be utilized, in some embodiments, to respond to either or both of the first-party and second-party alerts. In the case of the second-party insurance example alert, for example, a user (not shown) of the user device 206 may provide input (via the interface 220) to indicate that the user is aware of the second-party alert. In the case of a homeowners insurance policy and a temperature reading that is out of an acceptable range, such a response to the second-party alert may be received by the second-party server 210b and may cause additional processing. The second-party server 210b may compute, for example, that because the user responded to the alert within a threshold period of time (e.g., since the first-party alert and/or since the second-party alert), that an insurance discount should be applied or that a premium should not be increased (e.g., a positive result due to a perceived attentiveness of the user to the situation).

According to some embodiments, the sensor 202 may comprise a communications-enabled microcontroller device comprising an IoT device and gateway, such as an Edison™ Module or Board with Amazon® Web Services (AWS) protocol functionality, available from Intel® Corporation of Santa Clara, Calif. In some embodiments, the AWS (a service provided by Amazon.com, Inc. of Seattle, Wash.) may comprise the first-party server 210a and/or may store and/or implement one or more first-party thresholds and/or alerts. The AWS may, for example, store first-party threshold data, alert triggering data, sensor data, and/or user electronic-communications address data in the first-party database 240a, which may, for example, comprise an online and/or dynamic database system, such as AWS DynamoDB™ available from Amazon.com, Inc. In some embodiments, the sensor data may be provided to the user device 206 via the interface 220 by a JavaScript runtime service, such as the Node.js® service, e.g., as provided by the Node.js Foundation and Joyent, Inc., of San Francisco, Calif. The Node.js® service may, for example, generate, trigger, and/or manage data flow (e.g., sensor data) into the interface 220. According to some embodiments, first-party thresholds, triggers, and/or alerts may be computed and/or processed by an online logical server application, such as the AWS Lambda™ service provided by Amazon.com, Inc. In some embodiments, the AWS Lambda™ service may trigger first-party alerts (e.g., based upon readings from the sensor 202) and initiate transmittal of such alerts via a cloud-based messaging service, such as the Amazon® Simple Notification Service (Amazon® SNS or, simply SNS) available through Amazon.com, Inc. The SNS service may, for example, utilize the electronic communication address stored in the DynamoDB™ to trigger one or more alert messages (e.g., e-mails, text messages, Instant Messaging (IM) alerts) to the user and/or to the user device 206.

Fewer or more components 202, 204, 206, 210a-b, 220, 240a-c 242 and/or various configurations of the depicted components 202, 204, 206, 210a-b, 220, 240a-c 242 may be included in the system 200 without deviating from the scope of embodiments described herein. In some embodiments, the components 202, 204, 206, 210a-b, 220, 240a-c 242 may be similar in configuration and/or functionality to similarly named and/or numbered components as described herein. In some embodiments, the system 200 (and/or portions thereof) may comprise a systemic resource utilization analysis and/or management program, system, and/or platform programmed and/or otherwise configured to execute, conduct, and/or facilitate the method 300 of FIG. 3 herein, and/or portions thereof.

### III. Multi-Party Sensor Processes

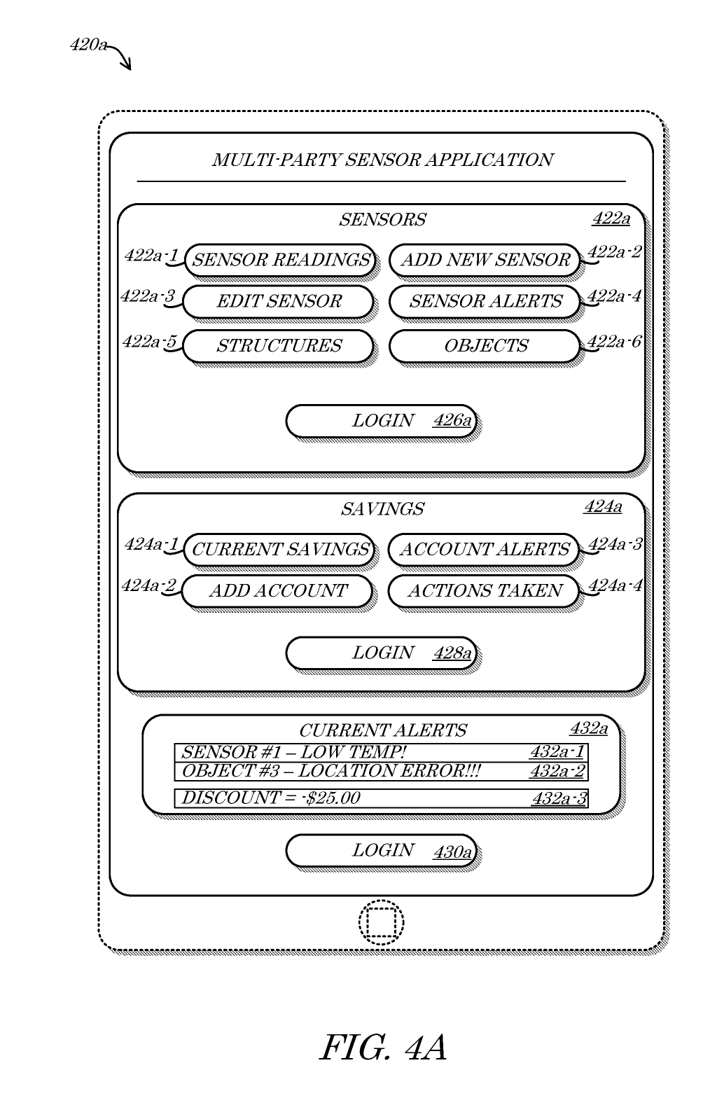

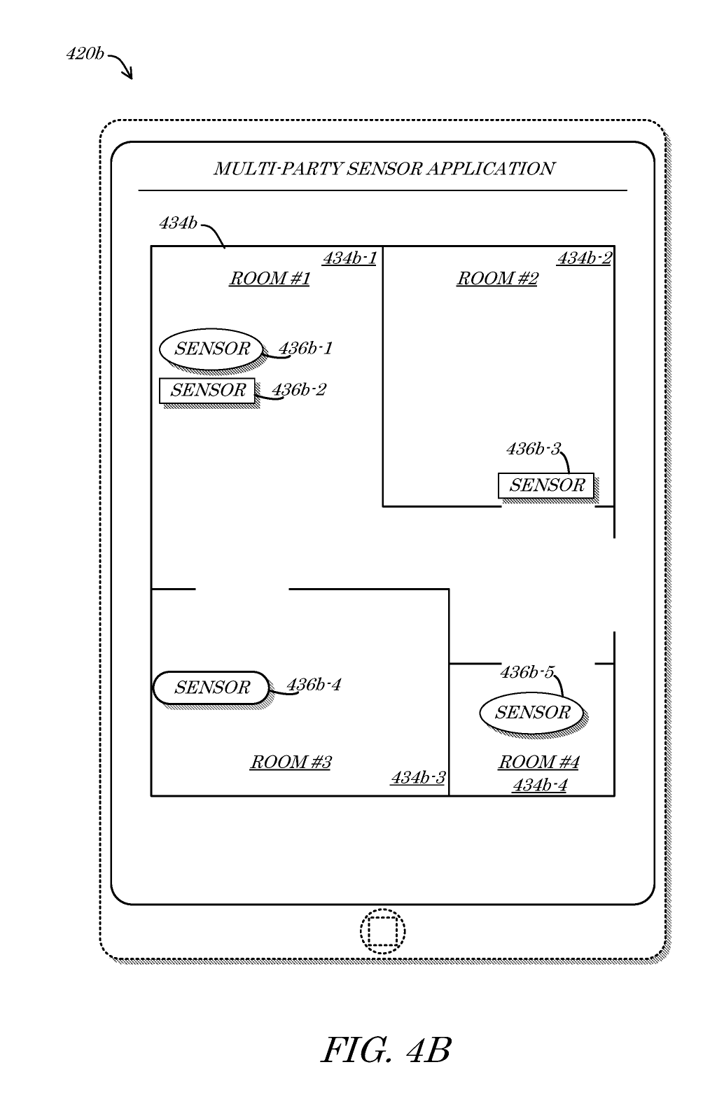

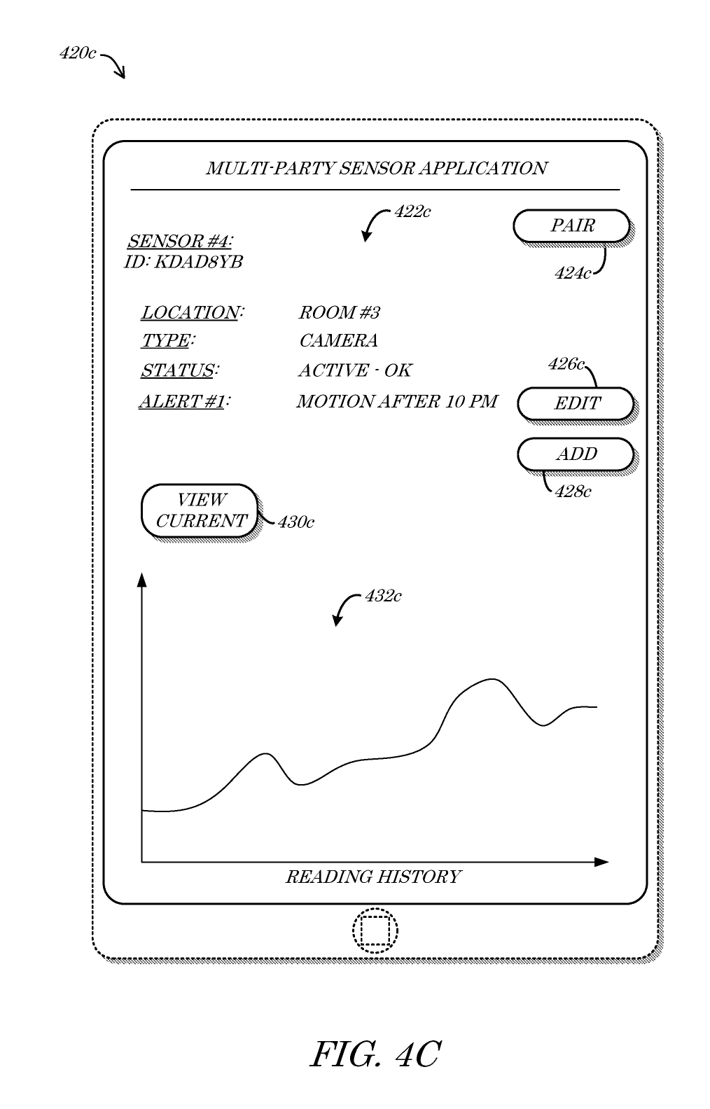

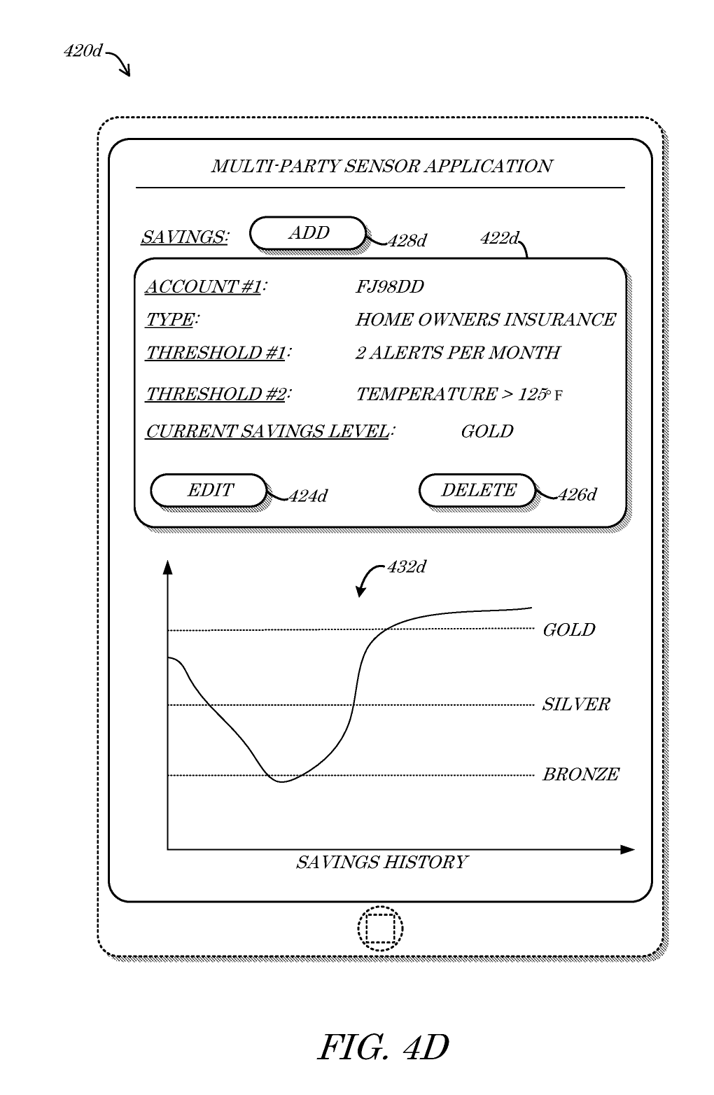

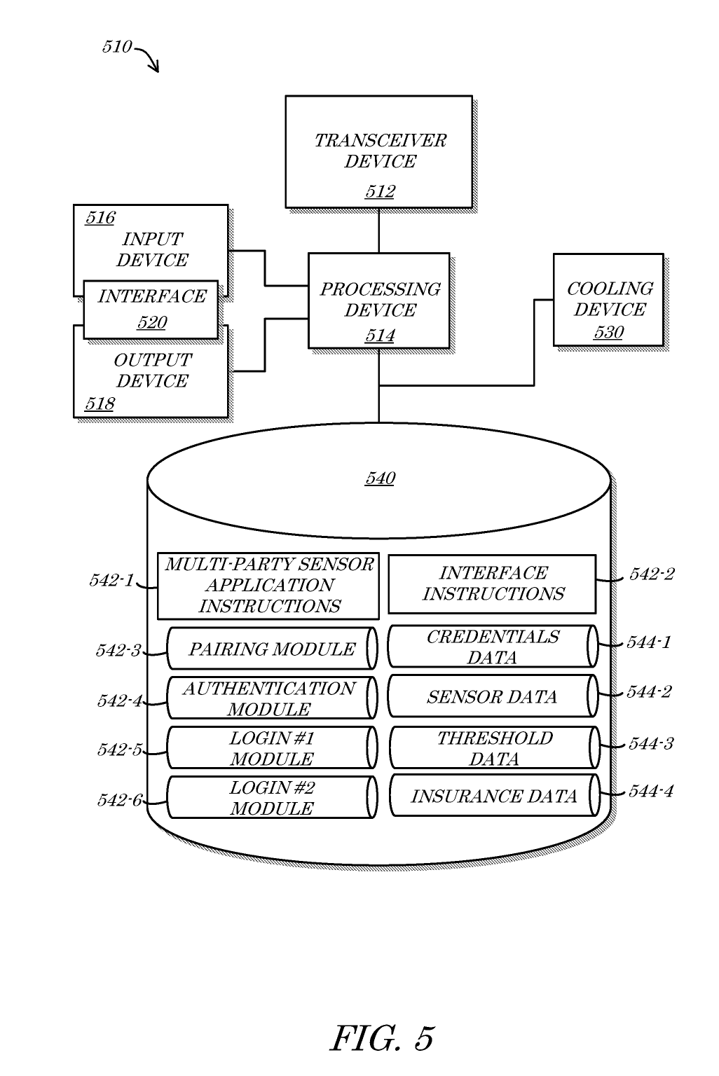

Turning now to FIG. 3, a flow diagram of a method 300 according to some embodiments is shown. In some embodiments, the method 300 may be performed and/or implemented by and/or otherwise associated with one or more specialized and/or specially-programmed computers (e.g., the mobile device 106, user device 206, and/or the controllers/servers 110a-b, 210a-b of FIG. 1 and/or FIG. 2 herein), specialized computers, computer terminals, computer servers, computer systems and/or networks, and/or any combinations thereof (e.g., by one or more multi-threaded and/or multi-core processing units of an insurance company data processing system). In some embodiments, the method 300 may be embodied in, facilitated by, and/or otherwise associated with various input mechanisms and/or interfaces (e.g., the interfaces 220, 420a-d, 520 of FIG. 2, FIG. 4A, FIG. 4B, FIG. 4C, FIG. 4D, and/or FIG. 5 herein).

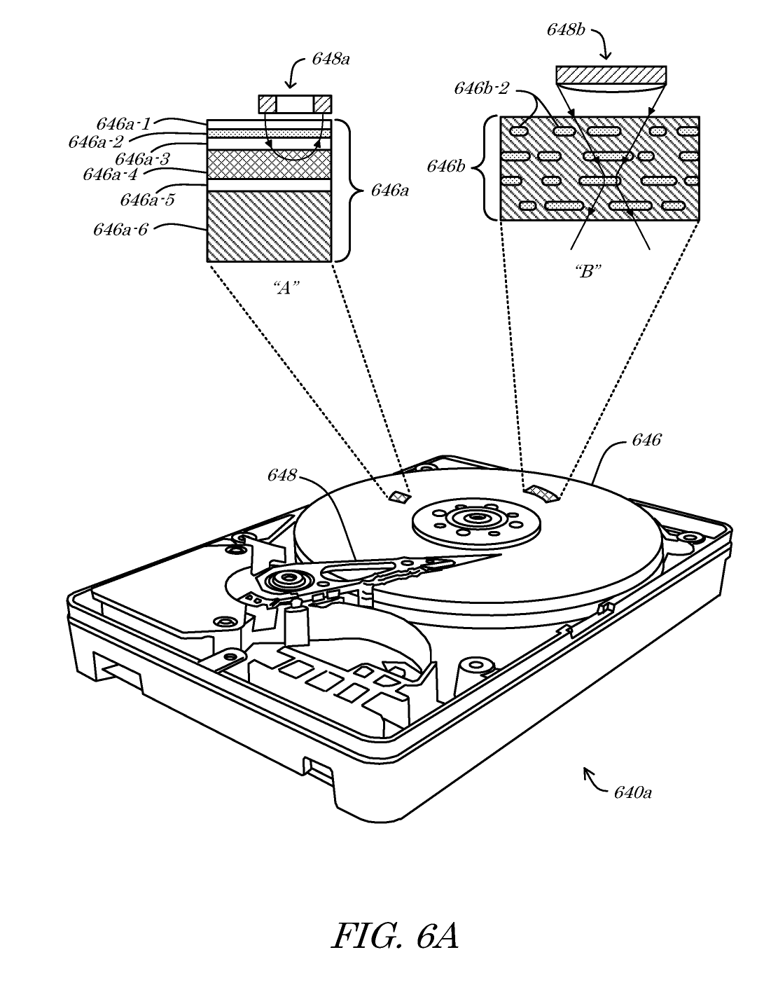

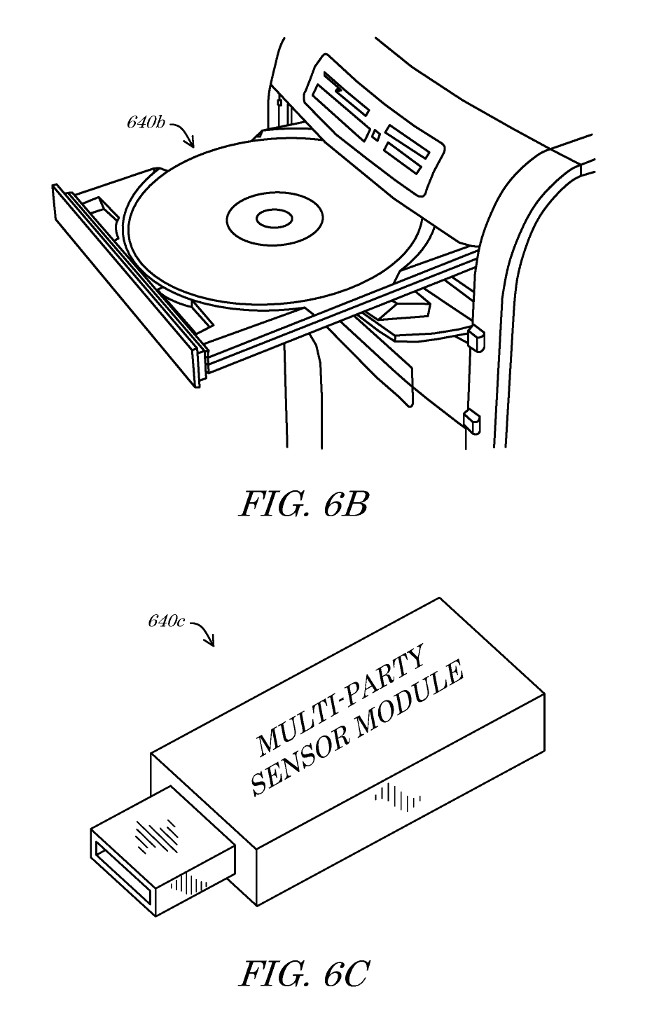

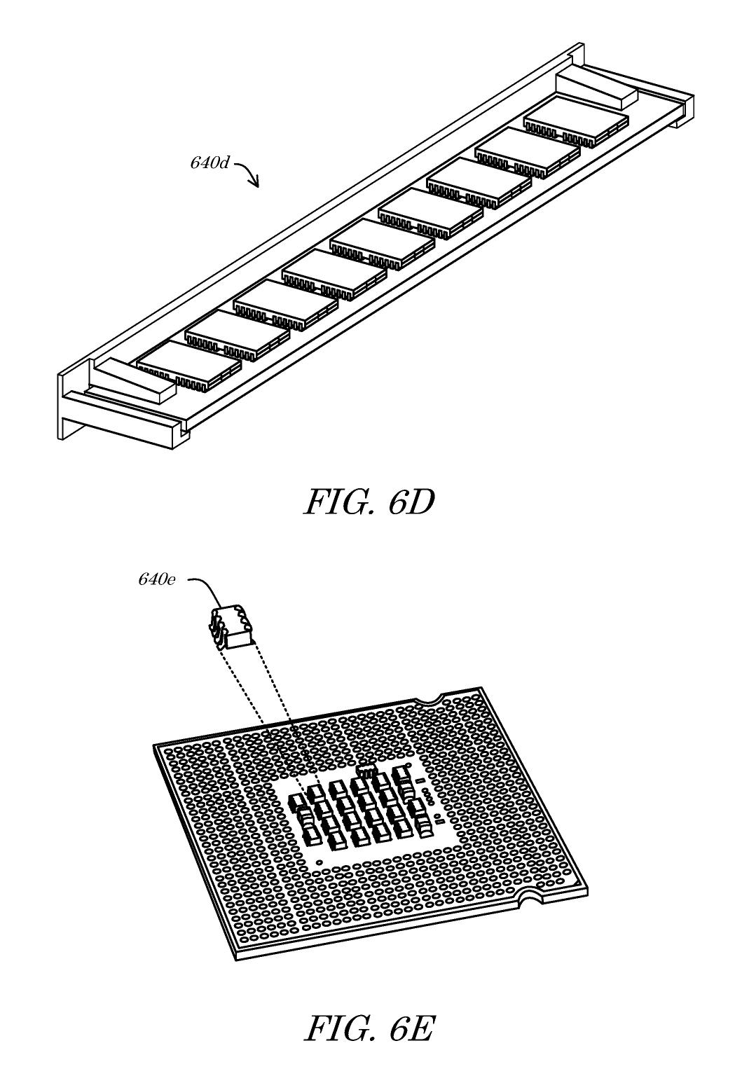

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 140, 240a-c 540, 640a-e of FIG. 1, FIG. 2, FIG. 5, FIG. 6A, FIG. 6B, FIG. 6C, FIG. 6D, and/or FIG. 6E herein) may store thereon instructions that when executed by a machine (such as a computerized processor) result in performance according to any one or more of the embodiments described herein.

According to some embodiments, the method 300 may comprise outputting (e.g., via a display device of a mobile electronic and/or computing device) a first graphical user interface comprising first interface features, at 302. The first interface features may, in some embodiments, permit and/or enable a user of a mobile computing device to acquire, e.g., wirelessly and from a sensor device, a device identifier. The first interface features may, for example, comprise a “pair sensor” button or feature that, when activated (e.g., by user input), triggers a pairing procedure or routine. The method 300 may comprise, for example, receiving (e.g., from user input received via the first interface features) sensor pairing input, at 304. The sensor pairing input may, for example, comprise a code and/or identifier of the sensor and/or a selection of one of a plurality of available wireless connections (e.g., automatically discovered by the mobile electronic device based on short-range signals emitted by the sensor). According to some embodiments, the method 300 may comprise pairing the sensor with the mobile electronic device, at 306. The sensor pairing input received at 304 may, for example, be transmitted to the sensor device and/or otherwise utilized to establish a communicative coupling between the sensor and the mobile electronic device. In some embodiments, the outputting of the first interface features at 302, the receiving of the sensor pairing input at 304, and/or the pairing of the sensor with the mobile electronic device at 306, may be conducted by a first software module executed by a processing unit of the mobile computing device. The first software module may, for example, comprise one of a plurality of software modules of a multi-party sensor application stored in local memory of the mobile electronic device.

In some embodiments, the method 300 may comprise outputting (e.g., via the display device of the mobile electronic and/or computing device) a second graphical user interface comprising second interface features, at 308. The second interface features may, in some embodiments, permit and/or enable a user to enter input defining first login credentials of the user. The second interface features may, for example, comprise a “sensor login” or “first-party login” button or feature that, when activated (e.g., by user input), triggers a first login procedure or routine and/or triggers a storing of first login credential data. The method 300 may comprise, for example, receiving (e.g., from user input received via the second interface features) first login credentials, at 310. The first login credentials may, for example, comprise a user and/or account name or identifier, the sensor identifier, and/or a password, pass-phrase, and/or security question and/or answer thereof. According to some embodiments, the received first login credential data may be stored in a local memory of the mobile electronic device and/or may be utilized to trigger and/or initiate a first login procedure, as described herein.

According to some embodiments, the method 300 may comprise outputting (e.g., via the display device of the mobile electronic and/or computing device) a third graphical user interface comprising third interface features, at 312. The third interface features may, in some embodiments, permit and/or enable a user to enter input defining second login credentials of the user. The third interface features may, for example, comprise an “insurance login” or “second-party login” button or feature that, when activated (e.g., by user input), triggers a second login procedure or routine and/or triggers a storing of second login credential data. The method 300 may comprise, for example, receiving (e.g., from user input received via the third interface features) second login credentials, at 314. The second login credentials may, for example, comprise a user and/or account name or identifier, the sensor identifier, and/or a password, pass-phrase, and/or security question and/or answer thereof. According to some embodiments, the received second login credential data may be stored in a local memory of the mobile electronic device and/or may be utilized to trigger and/or initiate a second login procedure, as described herein.

In some embodiments, the method 300 may comprise conducting (e.g., by the mobile electronic and/or computing device) first and second login procedures, at 316. The first login credentials received at 310 may be utilized, for example, to login to a first or first-party server and/or the second login credentials received at 314 may be utilized to login to a second or second-party server. According to some embodiments, either or both login procedures may be initiated upon and/or triggered by the receipt of the respective login credentials (e.g., at 310 and/or 314). In some embodiments, login credentials may be stored (e.g., in a local memory of the mobile electronic and/or computing device) and a login procedure may be initiated sometime after receiving and storing the respective credentials. According to some embodiments, the first and second login credentials may be stored and may be accessed and utilized upon a triggering action. The triggering action may, in some embodiments, comprise a receipt (e.g., via an interface output by the mobile electronic and/or computing device) of third or multi-party sensor application login credentials. The mobile electronic and/or computing device and/or a memory associated therewith may store, for example, a relationship between login credentials for a multi-party sensor application executed by the mobile electronic and/or computing device and the first and second login credentials. In some embodiments, the third or multi-party sensor application login credentials may be utilized to activate the multi-party sensor application and/or to trigger the conducting of one or more of the first and second login procedures (e.g., utilizing the stored first and second login credentials, respectively). According to some embodiments, the third or multi-party sensor application login credentials may be authenticated, such as by comparing the credentials with stored credential information associated with the multi-party sensor application. In some embodiments, the conducting of the first and second login procedures may only be initiated upon a positive authentication of the third or multi-party sensor application login credentials.

According to some embodiments, the conducting of the first and/or second login procedures may comprise transmitting the first and/or second login credentials to different appropriate servers (e.g., different network addresses and/or locations). The first login credentials may be transmitted to the first-party server, for example, and/or the second login credentials may be transmitted to the second-party server. In some embodiments, different network address information for each server may be stored by the mobile electronic device and utilized by the multi-party sensor application to transmit the login credentials to the appropriate servers. According to some embodiments, the login credentials may be authenticated by the respective servers and authentication information may be returned to the mobile electronic device. The mobile electronic device (and/or the multi-party sensor application execute thereby) may receive, for example, confirmation and/or validation of the authenticity of the first and second login credentials from the first-party and second-party servers, respectively.

In some embodiments, the conducting of the login procedures may comprise provision of additional data (e.g., other than a user identifier and password) to the respective servers. Data identifying the sensor and/or an electronic communication address of the mobile electronic device (and/or of a user thereof or an account associated therewith) may, for example, be transmitted by the mobile electronic device to the first-party server. In some embodiments, the first-party server may utilize the sensor identifier to activate or initialize the sensor and/or a sensor data feed to the first-party server and/or may utilize the electronic communication address to send one or more first-party alerts (e.g., based on first-party thresholds) to the mobile electronic device (and/or user thereof). According to some embodiments, data identifying a second-party industry-specific parameter may be transmitted by the mobile electronic device to the second-party server. Information identifying an insurance policy and/or other account not descriptive of the first-party, for example, may be transmitted to the second-party server. In some embodiments, the second-party server may utilize the second-party industry-specific parameter to identify the electronic communication address and/or to identify second-party data stored in relation to the user's account/mobile electronic device. The second-party server may, in some embodiments, utilize the electronic communication address to send one or more second-party alerts (e.g., based on second-party thresholds) to the mobile electronic device (and/or user thereof).

According to some embodiments, the outputting of the second interface features at 308, the receiving of the first login credentials at 310, and/or the conducting of the first login procedure (at 316), may be conducted by a second software module executed by a processing unit of the mobile computing device. The second software module may, for example, comprise one of a plurality of software modules of a multi-party sensor application stored in local memory of the mobile electronic device. In some embodiments, the outputting of the third interface features at 312, the receiving of the second login credentials at 314, and/or the conducting of the second login procedure (at 316), may be conducted by a third software module executed by a processing unit of the mobile computing device. The third software module may, for example, comprise one of a plurality of software modules of a multi-party sensor application stored in local memory of the mobile electronic device.

According to some embodiments, the method 300 may comprise receiving (e.g., by the mobile electronic and/or computerized device) a first-party alert, at 318. In the case that a first-party threshold is not met or is exceeded by a sensor reading, for example, an alert may be transmitted, pushed, and/or broadcast, e.g., to the electronic communication address. The first-party server may transmit a signal to the mobile electronic device, in some embodiments, that causes the mobile electronic device to output a visual and/or audible alert (e.g., to alert a user associated with, in, or at the location “A” of FIG. 1 of an out-of-range sensor reading). According to some embodiments, the first-party server may push a notification to a user's mobile electronic device, such as via proprietary messaging services (e.g., iMessge® or Microsoft® Message Services) or via text message (e.g., utilizing Short Message Service (SMS) protocols). In some embodiments, the method 300 may comprise outputting (e.g., via the display device of the mobile electronic and/or computing device) a fourth graphical user interface comprising fourth interface features, at 320. The fourth interface features may, in some embodiments, comprise a graphical representation of the first-party alert. The multi-party sensor application executed by the mobile electronic device may, for example, be responsive to the received indication by outputting, via an output device of the mobile electronic device, an indication of the first-party alert. In some embodiments, the first-party alert may be triggered or identified based on one or more first-party thresholds analyzed by the first-party server. According to some embodiments, the first-party thresholds may be established, defined, selected, viewed, activated or deactivated, and/or edited by the user via an interface generated by the multi-party sensor application on the mobile electronic device.

In some embodiments, the method 300 may comprise receiving (e.g., by the mobile electronic and/or computerized device) a second-party alert, at 322. In the case that a second-party threshold is not met or is exceeded by a sensor reading or based on one or more first-party alerts, for example, an alert may be transmitted, pushed, and/or broadcast, e.g., to the electronic communication address. The second-party server may transmit a signal to the mobile electronic device, in some embodiments, that causes the mobile electronic device to output a visual and/or audible alert (e.g., to alert a user associated with, in, or at the location “A” of FIG. 1 of a condition that is (or may) affect an insurance or other second-party industry parameter). According to some embodiments, the second-party server may push a notification to a user's mobile electronic device, such as via proprietary messaging services (e.g., iMessge® or Microsft® Message Services) or via text message (e.g., utilizing Short Message Service (SMS) protocols). In some embodiments, the method 300 may comprise outputting (e.g., via the display device of the mobile electronic and/or computing device) a fifth graphical user interface comprising fifth interface features, at 324. The fifth interface features may, in some embodiments, comprise a graphical representation of the second-party alert. The multi-party sensor application executed by the mobile electronic device may, for example, be responsive to the received indication by outputting, via an output device of the mobile electronic device, an indication of the second-party alert. In some embodiments, the second-party alert may be triggered or identified based on one or more second-party thresholds analyzed by the second-party server. According to some embodiments, the second-party thresholds may be established, defined, selected, viewed, activated or deactivated, and/or edited by the user via an interface generated by the multi-party sensor application on the mobile electronic device.

In some embodiments, the method 300 may comprise providing (e.g., via the interface of the mobile electronic and/or computerized device) an alert response, at 326. In response to either or both of the first-party and second-party alerts (received at 318 and 322, respectively), for example, a user may provide input, via the interface generated and output by the mobile electronic device. In some embodiments, the input may simply indicate that the user is aware of the alerted condition (e.g., an out-of-range sensor reading or a change in insurance policy parameters, as the case may be for the first-party and second-party alerts, respectively). In some embodiments, the input may comprise a responsive value, such as may be indicative of an answer to a question or query (e.g., “Have you shut off the water in the basement?” may be answered by interfacing with a particular portion of the fourth or fifth interface features and/or may trigger an input value of, e.g., one (1), for an answer of “yes”). In some embodiments, the input responsive to the alert(s) may be transmitted to one or more of the servers. Input responsive to the first-party alert received at 318 may, for example, be provided and/or defined via the fourth interface features and/or may trigger a data transmission to the first-party server. Input responsive to the second-party alert received at 322 may, for example, be provided and/or defined via the fifth interface features and/or may trigger a data transmission to the second-party server.

According to some embodiments, the receiving of the first-party alert at 318, the outputting of the fourth interface features at 320, and/or the providing of the alert response (at 326), may be conducted by a fourth software module executed by a processing unit of the mobile computing device. The fourth software module may, for example, comprise one of a plurality of software modules of a multi-party sensor application stored in local memory of the mobile electronic device. In some embodiments, the receiving of the second-party alert at 322, the outputting of the fifth interface features at 324, and/or the providing of the alert response (at 326), may be conducted by a fifth software module executed by a processing unit of the mobile computing device. The fifth software module may, for example, comprise one of a plurality of software modules of a multi-party sensor application stored in local memory of the mobile electronic device.

### IV. Multi-Party Sensor Example Interfaces

Referring now to 4A, FIG. 4B, FIG. 4C, and FIG. 4D, diagrams of example interfaces 420a-d according to some embodiments are shown (e.g., as output by a mobile electronic and/or computerized device, shown in dotted lines and not separately labeled). In some embodiments, the interfaces 420a-d may comprise one or more web pages, web forms, database entry forms, Application Program Interfaces (APIs), spreadsheets, tables, and/or applications or other Graphical User Interfaces (GUIs), such as may be defined and/or generated by a mobile device (e.g., smart phone) application. The interfaces 420a-d may, for example, be utilized by an end-user (e.g., a customer, consumer, and/or “user”) to interface with both first-party and second-party servers regarding a sensor (and/or associated data), as described herein. The interfaces 420a-d may, for example, comprise portions of a multi-party sensor application and/or platform programmed and/or otherwise configured to execute, conduct, and/or facilitate the method 300 of FIG. 3 herein, and/or portions thereof. In some embodiments, the interfaces 420a-d may be output via one or more specially-programmed computers (e.g., the mobile device 106, user device 206, and/or the controllers/servers 110a-b, 210a-b of FIG. 1 and/or FIG. 2 herein), specialized computers, computer terminals, computer servers, computer systems and/or networks, and/or any combinations thereof (e.g., by one or more multi-threaded and/or multi-core processing units of an insurance company data processing system).

According to some embodiments, a first interface 420a shown in FIG. 4A, may comprise an interface screen that allows a user to choose options from (i) a “sensors” menu 422a (e.g., to pair, manage, and/or obtain readings from a sensor and/or to effectuate communications with a first-party server) and/or (ii) a “savings” menu 424a (e.g., to manage, view, and/or obtain savings or incentives and/or to effectuate communications with a second-party server). As depicted, for example, the first interface 420a may provide functionality via the “sensors” menu 422a to allow the user to select a “sensor readings” option 422a-1 (e.g., that allows the user to view readings or measurements from a sensor), an “add new sensor” option 422a-2 (e.g., that allows the user to initiate a pairing of a new sensor—such as at 306 of the method 300 of FIG. 3 herein), an “edit sensor” option 422a-3 (e.g., that allows the user to edit sensor settings and/or thresholds), a “sensor alerts” option 422a-4 (e.g., that allows the user to view, add, and/or edit sensor alerts and/or sensor alert thresholds), a “structures” option 422a-5 (e.g., that allows the user to view and/or edit one or more structures associated with one or more sensors), and/or an “objects” option 422a-6 (e.g., that allows the user to view and/or edit one or more objects associated with one or more sensors). In some embodiments, the first interface 420a may provide functionality via the “savings” menu 424a to allow the user to select a “current savings” option 424a-1 (e.g., that allows the user to view current discounts, premiums, charges, payments, and/or incentives or awards), an “add account” option 424a-2 (e.g., that allows the user to add, register, and/or establish a new account with one or more second parties), an “account alerts” option 424a-3 (e.g., that allows the user to view, add, and/or edit savings alerts and/or savings alert thresholds), and/or an “actions taken” option 424a-4 (e.g., that allows the user to provide responses to alerts).

In some embodiments, the “sensors” menu 422a and the “savings” menu 424a may be representative of communications options to different servers. The “sensors” menu 422a may provide features for initiating and/or conducting communications with a first or first-party server, for example, while the “savings” menu 424a may provide features for initiating and/or conducting communications with one or more second or second-party servers. According to some embodiments, each respective server may be associated with and/or require different login credentials. In such embodiments, the first interface 420a (and/or the “sensors” menu 422a) may comprise a first login option 426a (e.g., via which first login credentials may be defined and/or input) and/or the first interface 420a (and/or the “savings” menu 424a) may comprise a second login option 428a (e.g., via which second login credentials may be defined and/or input). In some embodiments, the first interface 420a may include (and/or require) that third or multi-party sensor login credentials be provided, such as via a third or multi-party sensor login option 430a, as depicted. In some embodiments, the first login option 426a, the second login option 428a, and/or the multi-party sensor login option 430a may comprise second and/or third interface features provided to initiate and/or establish communications between a mobile device and each of a first-party server and a second-party server (e.g., via the same multi-party sensor application), as described herein.

According to some embodiments, the first interface 420a may comprise a “current alerts” portion 432a that may, for example, display data descriptive of one or more alerts that have been received (e.g., from one or more of the different servers). As depicted in FIG. 4A, a first alert 432a-1 may be indicative of a low temperature reading, a second alert 432a-2 may be indicative of a location anomaly (e.g., equipment being moved outside of a permitted geographic area), and/or a third alert 432a-3 may be indicative of a reduction in a discount amount. In some embodiments, the different alerts 432a-1, 432a-2, 432a-3 may be grouped, color-coded, and/or otherwise graphically depicted in different manners to distinguish alerts that come from different servers. The first two alerts 432a-1, 432a-2 may be separated from the third alert 432a-3, for example, to depict or represent that the first two alerts 432a-1, 432a-2 have been received from a first-party server, while the third alert 432a-3 has been received from a second-party server. According to some embodiments, the “current alerts” portion 432a (and/or an element thereof) may comprise fourth and/or fifth interface features provided to output first-party and/or second-party alerts to mobile devices, as described herein.

In some embodiments, the first interface 420a may comprise various sets of graphical elements or features that may, for example, be generated and/or output based on different criteria and/or triggers. According to some embodiments, the “add new sensor” option 422a-2 and/or the “edit sensor” option 422a-3 may comprise a first set of interface features provided to allow and/or establish communications between a user/mobile device and a sensor, as described herein. In some embodiments, the first login option 426a may comprise a second set of interface features provided to allow and/or establish communications between the user/mobile device and a first-party server, as described herein. According to some embodiments, the second login option 428a may comprise a third set of interface features provided to allow and/or establish communications between the user/mobile device and a second-party server, as described herein. In some embodiments, selection of any of the various options and/or features of the first interface 420a may cause one or more additional interfaces and/or interface elements to be generated and/or output.

According to some embodiments for example, a second interface 420b shown in FIG. 4B, may comprise an interface screen that depicts a particular structure 434b and a plurality of rooms or portions thereof, e.g., a first room 434b-1, a second room 434b-2, a third room 434b-3, and/or a fourth room 434b-4. In some embodiments, the second interface 420b may comprise graphical representations of a plurality of sensors 436b-1, 436b-2, 436b-3, 436b-4, 436b-5 disposed in, coupled to, and/or associated with the particular structure 434b. According to some embodiments, the second interface 420b may be generated and/or output in response to an activation and/or selection of a particular input option and/or feature such as the “structures” option 422a-5 of FIG. 4A. In some embodiments, the second interface 420b may comprise a specialized graphical manner of selecting and/or viewing the status of (and/or data from) one or more of the sensors 436b-1, 436b-2, 436b-3, 436b-4, 436b-5. Any or all of the sensors 436b-1, 436b-2, 436b-3, 436b-4, 436b-5 may be otherwise accessed, for example, by activation and/or selection of a different input option such as the “sensor readings” option 422a-1, the “edit sensor” option 422a-2, and/or the “sensor alerts” option 422a-4, all of FIG. 4A.

In some embodiments, different types and/or statuses (e.g., reading values in relation to one or more sensor thresholds) of the sensors 436b-1, 436b-2, 436b-3, 436b-4, 436b-5 may be indicated graphically, such as by different shaped elements (as depicted in FIG. 4B), different colors, animations, etc. As shown in FIG. 4B, for example, a first sensor 436b-1 may be a first type of sensor (e.g., a water sensor) and/or have a first status (e.g., within threshold limits) represented by the oval shape, which may be similarly represented for a fifth one of the sensors 436b-5. According to some embodiments, a second sensor 436b-2 may be a second type of sensor (e.g., a motion sensor) and/or have a second status (e.g., above a threshold limit) represented by the rectangular shape, which may be similarly represented for a third sensor 436b-3. In some embodiments, a fourth sensor 436b-4 may be a third type of sensor (e.g., a camera) and/or have a third status (e.g., activated or powered on) represented by the rounded rectangular shape. In some embodiments, selection of any of the various options and/or features of the second interface 420b may cause one or more additional interfaces and/or interface elements to be generated and/or output.

Turning to FIG. 4C, for example, a third interface 420c may comprise an interface screen that depicts a settings, readings, and/or configuration screen for a particular sensor (e.g., one of the sensors 436b-1, 436b-2, 436b-3, 436b-4, 436b-5 depicted in the second interface 420b in FIG. 4B). According to some embodiments, the third interface 420c may be generated and/or output in response to an activation and/or selection of a particular input option and/or feature, such as selection of one of the sensors 436b-1, 436b-2, 436b-3, 436b-4, 436b-5 via the second interface 434b of FIG. 4B and/or selection of any of the “sensor readings” option 422a-1, the “edit sensor” option 422a-3, and/or the “sensor alerts” option 422a-4, all of FIG. 4A. The third interface 420c may comprise, in some embodiments, sensor data 422c, such as a sensor identifier, location, type, status, and/or alert or threshold information. In some embodiments, the third interface 420c may comprise a “pair” option 424c, which may, for example, initiate a pairing sequence with one or more particular sensors (e.g., the “pair” option 424c may comprise the first interface feature(s) output at 302 of the method 300 of FIG. 3 herein). According to some embodiments, the third interface 420c may comprise an “edit” option 426c, an “add” option 428c, and/or a “view current” option 430c. The “edit” option 426c may permit the user to define, edit, or modify one or more sensor alerts (such as the “alert #1” shown) and/or the “add” option 428c may permit the user to define, select, and/or add one or more new or additional thresholds or alerts (e.g., first-party thresholds and/or alerts), either or both, e.g., with respect to and/or via communications with a first-party server (not shown). According to some embodiments, the “view current” option 430c may permit the user to view current readings, measurements, and/or data (e.g., photos, audio, and/or video) from the selected sensor (e.g., “sensor #4”). The “view current” option 430c may, for example, initiate communications with either or both of the sensor (not shown) and/or the first-party server that, e.g., receives a stream of sensor data from the sensor. In some embodiments, the third interface 420c may comprise a graph 432c that may depict, for example, historic sensor data such as sensor readings as-recorded or observed over a previous time period, such as a previous day, week, month, year, etc.

Referring now to FIG. 4D, a fourth interface 420d may comprise an interface screen that depicts savings and/or other second-party data. According to some embodiments, the fourth interface 420d may be generated and/or output in response to an activation and/or selection of a particular input option and/or feature such as either of the “current savings” option 424a-1 or the “account alerts” option 424a-3 of FIG. 4A. In the ongoing and non-limiting example of the second-party comprising an insurance company, for example, the fourth interface 420d may comprise second-party data 422d descriptive of an account number (e.g., an insurance policy number), an account type (e.g., the depicted “home owners insurance”), a first second-party threshold (e.g., the depicted “2 alerts per month”), a second second-party threshold (e.g., the depicted “temperature >125° F.”), and/or a current savings level (e.g., the depicted “gold” level). Any or all of the second-party data 422d may be based, at least in part, on one or more items of sensor data (such as one or more sensor reading values) and/or first-party thresholds or alerts. The first second-party threshold may, for example, be based on and/or triggered by first-party threshold and/or alert data received by a second-party server (not shown) from the first-party server. In the depicted example, should a number of first-party alerts (e.g., sensor threshold triggers) occur within a given month, the “threshold #1” will be exceeded and, in some embodiments, a second-party alert may be generated. According to some embodiments, the second second-party threshold may be based on and/or triggered by sensor data (e.g., received by the second-party server from the first-party server). In the depicted example, should a temperature reading (e.g., for a dryer vent temperature sensor—not shown) exceed the stated threshold value for “threshold #2” (which may or may not correspond to a first-party threshold), the “threshold #2” will be exceeded and, in some embodiments, a second-party alert may be generated.

In some embodiments, the fourth interface 420d may comprise an “edit” option 424d and/or a “delete” option 426d. The “edit” option 424d may permit the user to manage and/or edit one or more of the second-party thresholds and/or alerts, for example, and/or may permit the user to edit or manage any other information for the “account #1”. According to some embodiments, the “delete” option 426d may permit the user to disable, remove, or delete one or more second-party thresholds and/or alerts. In some embodiments, the fourth interface 420d may comprise an “add” option 428d which may, for example, permit the user to add a new second-party threshold, second-party alert, and/or second party. The “add” option 428d may, in some embodiments, permit the user to link multiple second-parties to the multi-party sensor application (e.g., that generates the fourth interface 420d). In some embodiments, multiple accounts and/or second-party data 422d sections may be added for a single second-party (e.g., multiple insurance policies) and/or for different second-parties, e.g., in different industries (e.g., having additional second-party data available from a different second-party server and/or data store).

According to some embodiments, the fourth interface 420d may comprise a savings graph 432d. The savings graph 432d may, for example, depict one or more savings, discount, premium, cost, award, and/or incentive data values over time. In some embodiments (e.g., as depicted in FIG. 4D), the savings graph 432d may plot values for one or more metrics with respect to a plurality of savings/incentive levels, tiers, and/or categories. The savings graph 432d may, for example, plot an inverse of a number of second-party (and/or first-party) alerts that have occurred, such that fewer alerts equates to higher savings tiers such as the “gold” level depicted. In some embodiments, different monetary savings and/or discount amounts may be assigned to the different depicted tiers. In such a manner, for example, the user may visualize how data captured by their connected sensor has affected their second-party (e.g., insurance) metric (e.g., discount, surcharge, premium, deductible, etc.).

While various components of the interfaces 420a-d have been described with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

### V. Multi-Party Sensor Apparatus and Articles of Manufacture

Turning to FIG. 5, a block diagram of an apparatus 510 according to some embodiments is shown. In some embodiments, the apparatus 510 may be similar in configuration and/or functionality to any of the sensor devices 102a-n, 202, the user devices 106, 206, and/or the controller devices/servers 110a-b, 210a-b of FIG. 1 and/or FIG. 2 herein, and/or may otherwise comprise a portion of the systems 100, 200 of FIG. 1 and/or FIG. 2 herein. The apparatus 510 may, for example, execute, process, facilitate, and/or otherwise be associated with the method 300 described in conjunction with FIG. 3 herein, and/or one or more portions thereof. In some embodiments, the apparatus 510 may comprise a transceiver device 512, one or more processing devices 514, an input device 516, an output device 518, an interface 520, a cooling device 530, and/or a memory device 540 (storing various programs and/or instructions 542 and data 544). According to some embodiments, any or all of the components 512, 514, 516, 518, 520, 530, 540, 542, 544 of the apparatus 510 may be similar in configuration and/or functionality to any similarly named and/or numbered components described herein. Fewer or more components 512, 514, 516, 518, 520, 530, 540, 542, 544 and/or various configurations of the components 512, 514, 516, 518, 520, 530, 540, 542, 544 may be included in the apparatus 510 without deviating from the scope of embodiments described herein.

In some embodiments, the transceiver device 512 may comprise any type or configuration of bi-directional electronic communication device that is or becomes known or practicable. The transceiver device 512 may, for example, comprise a Network Interface Card (NIC), a telephonic device, a cellular network device, a router, a hub, a modem, and/or a communications port or cable. In some embodiments, the transceiver device 512 may be coupled to provide data to a user device (not shown in FIG. 5), such as in the case that the apparatus 510 is utilized to provide a multi-party sensor interface (e.g., the interface 520) to a user and/or to provide multi-party sensor analysis, classification, and/or data processing results, such as based on sensor data (e.g., first-party data) and/or second-party data, as described herein. The transceiver device 512 may, for example, comprise a cellular telephone network transmission device that sends signals indicative of multi-party sensor data processing interface components and/or data processing result-based commands to a user handheld, mobile, and/or telephone device. According to some embodiments, the transceiver device 512 may also or alternatively be coupled to the processing device 514. In some embodiments, the transceiver device 512 may comprise an IR, RF, Bluetooth™, and/or Wi-Fi® network device coupled to facilitate communications between the processing device 514 and another device (such as a user device and/or a third-party device; not shown in FIG. 5).

According to some embodiments, the processing device 514 may be or include any type, quantity, and/or configuration of electronic and/or computerized processor that is or becomes known. The processing device 514 may comprise, for example, an Intel® IXP 2800 network processor or an Intel® XEON™ Processor coupled with an Intel® E7501 chipset. In some embodiments, the processing device 514 may comprise multiple, cooperative, and/or inter-connected processors, microprocessors, and/or micro-engines (e.g., a computational processing device and/or server cluster). According to some embodiments, the processing device 514 (and/or the apparatus 510 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 510 comprises a server such as a blade server, necessary power may be supplied via a standard AC outlet, power strip, surge protector, a PDU, and/or Uninterruptible Power Supply (UPS) device (none of which are shown in FIG. 5).

In some embodiments, the input device 516 and/or the output device 518 are communicatively coupled to the processing device 514 (e.g., via wired and/or wireless connections and/or pathways) and they may generally comprise any types or configurations of input and output components and/or devices that are or become known, respectively. The input device 516 may comprise, for example, a keyboard that allows an operator of the apparatus 510 to interface with the apparatus 510 (e.g., by a user, such as an insurance company analyzing and processing first-party sensor, threshold, and/or alert data, as described herein). The output device 518 may, according to some embodiments, comprise a display screen and/or other practicable output component and/or device. The output device 518 may, for example, provide an augmented reality interface such as the interface 520 to a user (e.g., via a website). In some embodiments, the interface 520 may comprise portions and/or components of either or both of the input device 516 and the output device 518. According to some embodiments, the input device 516 and/or the output device 518 may, for example, comprise and/or be embodied in an input/output and/or single device such as a touch-screen monitor or display (e.g., that enables both input and output via the interface 520).

In some embodiments, the apparatus 510 may comprise the cooling device 530. According to some embodiments, the cooling device 530 may be coupled (physically, thermally, and/or electrically) to the processing device 514 and/or to the memory device 540. The cooling device 530 may, for example, comprise a fan, heat sink, heat pipe, radiator, cold plate, and/or other cooling component or device or combinations thereof, configured to remove heat from portions or components of the apparatus 510.

The memory device 540 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 540 may, according to some embodiments, store one or more of multi-party sensor application instructions 542-1, interface instructions 542-2, a pairing module 542-3, an authentication module 542-4, a first login module 542-5, a second login module 542-6, credentials data 544-1, sensor (e.g., first-party) data 544-2, threshold data 544-3, and/or insurance (and/or other second-party) data 544-4. In some embodiments, the multi-party sensor application instructions 542-1, interface instructions 542-2, a pairing module 542-3, an authentication module 542-4, a first login module 542-5, a second login module 542-6, credentials data 544-1, sensor data 544-2, threshold data 544-3, and/or insurance data 544-4 may be utilized by the processing device 514 to provide output information via the output device 518 and/or the transceiver device 512.

According to some embodiments, the multi-party sensor application instructions 542-1 may be operable to cause the processing device 514 to process the credentials data 544-1, sensor data 544-2, threshold data 544-3, and/or insurance data 544-4. Credentials data 544-1, sensor data 544-2, threshold data 544-3, and/or insurance data 544-4 received via the input device 516 and/or the transceiver device 512 may, for example, be analyzed, sorted, filtered, decoded, decompressed, ranked, scored, plotted, and/or otherwise processed by the processing device 514 in accordance with the multi-party sensor application instructions 542-1. In some embodiments, credentials data 544-1, sensor data 544-2, threshold data 544-3, and/or insurance data 544-4 may be fed (e.g., input) by the processing device 514 through one or more mathematical and/or statistical formulas and/or models in accordance with the multi-party sensor application instructions 542-1 to provide communications and/or data transmissions between a mobile device and a plurality of servers and/or sensors, in accordance with embodiments described herein.

In some embodiments, interface instructions 542-2 may be operable to cause the processing device 514 to process the credentials data 544-1, sensor data 544-2, threshold data 544-3, and/or insurance data 544-4. Credentials data 544-1, sensor data 544-2, threshold data 544-3, and/or insurance data 544-4 received via the input device 516 and/or the transceiver device 512 may, for example, be analyzed, sorted, filtered, decoded, decompressed, ranked, scored, plotted, and/or otherwise processed by the processing device 514 in accordance with the interface instructions 542-2. In some embodiments, credentials data 544-1, sensor data 544-2, threshold data 544-3, and/or insurance data 544-4 may be fed (e.g., input) by the processing device 514 through one or more mathematical and/or statistical formulas and/or models in accordance with the interface instructions 542-2 to define, generate, provide, and/or output an interface operable to facilitate communications with a plurality of servers of different parties and/or to provide sensor-based alerts from multiple parties in a graphical and/or interactive format, in accordance with embodiments described herein.

According to some embodiments, the pairing module 542-3 may be operable to cause the processing device 514 to process the credentials data 544-1, sensor data 544-2, threshold data 544-3, and/or insurance data 544-4. Credentials data 544-1, sensor data 544-2, threshold data 544-3, and/or insurance data 544-4 received via the input device 516 and/or the transceiver device 512 may, for example, be analyzed, sorted, filtered, decoded, decompressed, ranked, scored, plotted, and/or otherwise processed by the processing device 514 in accordance with the pairing module 542-3. In some embodiments, credentials data 544-1, sensor data 544-2, threshold data 544-3, and/or insurance data 544-4 may be fed (e.g., input) by the processing device 514 through one or more mathematical and/or statistical formulas and/or models in accordance with the pairing module 542-3 to provide and/or establish communications and/or communicative coupling between a mobile device and one or more multi-party sensors, in accordance with embodiments described herein.

In some embodiments, the authentication module 542-4 may be operable to cause the processing device 514 to process the credentials data 544-1, sensor data 544-2, threshold data 544-3, and/or insurance data 544-4. Credentials data 544-1, sensor data 544-2, threshold data 544-3, and/or insurance data 544-4 received via the input device 516 and/or the transceiver device 512 may, for example, be analyzed, sorted, filtered, decoded, decompressed, ranked, scored, plotted, and/or otherwise processed by the processing device 514 in accordance with the authentication module 542-4. In some embodiments, credentials data 544-1, sensor data 544-2, threshold data 544-3, and/or insurance data 544-4 may be fed (e.g., input) by the processing device 514 through one or more mathematical and/or statistical formulas and/or models in accordance with the authentication module 542-4 to input, receive, identify, and/or authenticate multi-party sensor application credentials, in accordance with embodiments described herein.

According to some embodiments, the first login module 542-5 may be operable to cause the processing device 514 to process the credentials data 544-1, sensor data 544-2, threshold data 544-3, and/or insurance data 544-4. Credentials data 544-1, sensor data 544-2, threshold data 544-3, and/or insurance data 544-4 received via the input device 516 and/or the transceiver device 512 may, for example, be analyzed, sorted, filtered, decoded, decompressed, ranked, scored, plotted, and/or otherwise processed by the processing device 514 in accordance with the first login module 542-5. In some embodiments, credentials data 544-1, sensor data 544-2, threshold data 544-3, and/or insurance data 544-4 may be fed (e.g., input) by the processing device 514 through one or more mathematical and/or statistical formulas and/or models in accordance with the first login module 542-5 to input, receive, identify, and/or authenticate (e.g., via communications with a first-party server) first login credentials, in accordance with embodiments described herein.

In some embodiments, the second login module 542-6 may be operable to cause the processing device 514 to process the credentials data 544-1, sensor data 544-2, threshold data 544-3, and/or insurance data 544-4. Credentials data 544-1, sensor data 544-2, threshold data 544-3, and/or insurance data 544-4 received via the input device 516 and/or the transceiver device 512 may, for example, be analyzed, sorted, filtered, decoded, decompressed, ranked, scored, plotted, and/or otherwise processed by the processing device 514 in accordance with the second login module 542-6. In some embodiments, credentials data 544-1, sensor data 544-2, threshold data 544-3, and/or insurance data 544-4 may be fed (e.g., input) by the processing device 514 through one or more mathematical and/or statistical formulas and/or models in accordance with the second login module 542-6 to input, receive, identify, and/or authenticate (e.g., via communications with a second-party server) second login credentials, in accordance with embodiments described herein.

Any or all of the exemplary instructions 542 and data types 544 described herein and other practicable types of data may be stored in any number, type, and/or configuration of memory devices that is or becomes known. The memory device 540 may, for example, comprise one or more data tables or files, databases, table spaces, registers, and/or other storage structures. In some embodiments, multiple databases and/or storage structures (and/or multiple memory devices 540) may be utilized to store information associated with the apparatus 510. According to some embodiments, the memory device 540 may be incorporated into and/or otherwise coupled to the apparatus 510 (e.g., as shown) or may simply be accessible to the apparatus 510 (e.g., externally located and/or situated). According to some embodiments, the apparatus 510 may comprise a system and/or a portion of a system that may, for example, include additional devices and/or objects, local or remote, than are depicted in FIG. 5. The apparatus 510 may comprise, for example, a system for facilitating multi-party sensor credentials authentication, first-party server credentials authentication, second-party server credentials authentication, multi-party sensor pairing, first-party server to second-party server communications, definition and/or implementation of first-party and second-party thresholds and associated alerts, and computation and/or identification of second-party savings, discounts, and/or other incentives (e.g., based on first-party thresholds, alerts, and/or multi-party sensor data), as described herein.

Referring to FIG. 6A, FIG. 6B, FIG. 6C, FIG. 6D, and FIG. 6E, perspective diagrams of exemplary data storage devices 640a-e according to some embodiments are shown. The data storage devices 640a-e may, for example, be utilized to store instructions and/or data such as the multi-party sensor application instructions 542-1, interface instructions 542-2, a pairing module 542-3, an authentication module 542-4, a first login module 542-5, a second login module 542-6, credentials data 544-1, sensor data 544-2, threshold data 544-3, and/or insurance data 544-4, each of which is described in reference to FIG. 5 herein. In some embodiments, instructions stored on the data storage devices 640a-e may, when executed by one or more threads, cores, and/or processors (such as the processing device 514 of FIG. 5), cause the implementation of and/or facilitate the method 300 described in conjunction with FIG. 3 herein, and/or portions thereof.

According to some embodiments, a first data storage device 640a may comprise one or more various types of internal and/or external hard drives. The first data storage device 640a may, for example, comprise a data storage medium 646 that is read, interrogated, and/or otherwise communicatively coupled to and/or via a disk reading device 648. In some embodiments, the first data storage device 640a and/or the data storage medium 646 may be configured to store information utilizing one or more magnetic, inductive, and/or optical means (e.g., magnetic, inductive, and/or optical-encoding). The data storage medium 646, depicted as a first data storage medium 646a for example (e.g., breakout cross-section “A”), may comprise one or more of a polymer layer 646a-1, a magnetic data storage layer 646a-2, a non-magnetic layer 646a-3, a magnetic base layer 646a-4, a contact layer 646a-5, and/or a substrate layer 646a-6. According to some embodiments, a magnetic read head 646a may be coupled and/or disposed to read data from the magnetic data storage layer 646a-2.

In some embodiments, the data storage medium 646, depicted as a second data storage medium 646b for example (e.g., breakout cross-section “B”), may comprise a plurality of data points 646b-2 disposed with the second data storage medium 646b. The data points 646b-2 may, in some embodiments, be read and/or otherwise interfaced with via a laser-enabled read head 648b disposed and/or coupled to direct a laser beam through the second data storage medium 646b.

In some embodiments, a second data storage device 640b may comprise a CD, CD-ROM, DVD, Blu-Ray™ Disc, and/or other type of optically-encoded disk and/or other storage medium that is or becomes know or practicable. In some embodiments, a third data storage device 640c may comprise a USB keyfob, dongle, and/or other type of flash memory data storage device that is or becomes know or practicable. In some embodiments, a fourth data storage device 640d may comprise RAM of any type, quantity, and/or configuration that is or becomes practicable and/or desirable. In some embodiments, the fourth data storage device 640d may comprise an off-chip cache such as a Level 2 (L2) cache memory device. According to some embodiments, a fifth data storage device 640e may comprise an on-chip memory device such as a Level 1 (L1) cache memory device.

The data storage devices 640a-e may generally store program instructions, code, and/or modules that, when executed by a processing device cause a particular machine to function in accordance with one or more embodiments described herein. The data storage devices 640a-e depicted in FIG. 6A, FIG. 6B, FIG. 6C, FIG. 6D, and FIG. 6E are representative of a class and/or subset of computer-readable media that are defined herein as “computer-readable memory” (e.g., non-transitory memory devices as opposed to transmission devices or media).

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined herein and includes many exemplary protocols that are also applicable here.

### VI. Terms and Rules of Interpretation

Throughout the description herein and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. While not generally limiting and while not limiting for all described embodiments, in some embodiments, the terms are specifically limited to the example definitions and/or examples provided. Other terms are defined throughout the present description.

Some embodiments described herein are associated with a “module”. As utilized herein, the term “module” may generally be descriptive of any combination of hardware, electronic circuitry and/or other electronics (such as logic chips, logical gates, and/or other electronic circuit elements or components), hardware (e.g., physical devices such as hard disks, solid-state memory devices, and/or computer components such as processing units or devices), firmware, and/or software or microcode.

Some embodiments described herein are associated with a “user device”, a “remote device”, or a “network device”. As used herein, each of a “user device” and a “remote device” is a subset of a “network device”. The “network device”, for example, may generally refer to any device that can communicate via a network, while the “user device” may comprise a network device that is owned and/or operated by or otherwise associated with a particular user (and/or group of users—e.g., via shared login credentials and/or usage rights), and while a “remote device” may generally comprise a device remote from a primary device or system component and/or may comprise a wireless and/or portable network device. Examples of user, remote, and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. User, remote, and/or network devices may, in some embodiments, comprise one or more network components.

As used herein, the term “network component” may refer to a user, remote, or network device, or a component, piece, portion, or combination of user, remote, or network devices. Examples of network components may include a Static Random Access Memory (SRAM) device or module, a network processor, and a network communication path, connection, port, or cable.

In addition, some embodiments are associated with a “network” or a “communication network.” As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as used herein (unless specified otherwise), may generally refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant reserves the right to file additional applications to pursue patents for subject matter that has been disclosed and enabled, but not claimed in the present application.

What is claimed is:

1. An application executed by a mobile computing device, the application comprising a plurality of software modules stored in a local non-transitory memory of the mobile computing device, the plurality of software modules, comprising:
(a) a first software module that, when executed by a processing unit of the mobile computing device, causes the mobile computing device to output, via a display device of the mobile computing device, a first graphical user interface comprising first interface features that permit a user of the mobile computing device to acquire, wirelessly and from a sensor device, a device identifier;
(b) a second software module that, when executed by the processing unit of the mobile computing device, causes the mobile computing device to (i) output, via the display device of the mobile computing device, a second graphical user interface comprising second interface features that accept as input and from the user of the mobile computing device, login credentials of the user, and (ii) authenticate the login credentials of the user;
(c) a third software module that, after the authentication of the login credentials of the user and when executed by the processing unit of the mobile computing device, causes the mobile computing device to transmit (i) an indication of the authenticated login credentials, (ii) the device identifier, and (iii) an electronic communications address of the user, to a first remote server device, the first remote server device being in remote wireless communication with the sensor device and being operable, upon receiving a sensor reading from the sensor device, to execute stored rules to determine that a notification should be sent to the electronic communications address of the user;
(d) a fourth software module that, after the authentication of the login credentials of the user and when executed by the processing unit of the mobile computing device, causes the mobile computing device to transmit (i) the indication of the authenticated login credentials and (ii) an identifier of an insurance policy of the user, to a second remote server device, the second remote server device being in remote communication with the first remote server device and being operable, upon acquiring data indicative of the sensor reading from the sensor device, to execute stored rules to calculate an adjustment to a monetary parameter of the insurance policy; and
(e) a fifth software module that, when executed by the processing unit of the mobile computing device, causes the mobile computing device to output, via the display device of the mobile computing device, a third graphical user interface comprising third interface features that display to the user each of (i) a graphical representation of the notification, from the first remote server device, of the sensor reading and (ii) a graphical representation of the monetary parameter of the insurance policy, from the second remote server device, as adjusted in response to the sensor reading.

2. An application executed by a mobile computing device, the application comprising a plurality of software modules stored in a local non-transitory memory of the mobile computing device, the plurality of software modules, comprising:
(a) a first software module that, when executed by a processing unit of the mobile computing device, causes the mobile computing device to:
(i) output, via a display device of the mobile computing device, a first graphical user interface comprising first interface features;
(ii) receive, via the first interface features, sensor pairing input; and
(iii) pair, utilizing the sensor pairing input, a wireless sensor with the mobile computing device;
(b) a second software module that, when executed by the processing unit of the mobile computing device, causes the mobile computing device to:
(i) output, via the display device of the mobile computing device, a second graphical user interface comprising second interface features;
(ii) receive, via the second interface features, first login credentials; and
(iii) authenticate, via communication with a first remote server, the first login credentials;
(c) a third software module that, when executed by the processing unit of the mobile computing device, causes the mobile computing device to:
(i) output, via the display device of the mobile computing device, a third graphical user interface comprising third interface features;
(ii) receive, via the third interface features, second login credentials; and
(iii) authenticate, via communication with a second remote server, the second login credentials;
(d) a fourth software module that, after the authentication of the first login credentials and when executed by the processing unit of the mobile computing device, causes the mobile computing device to:
(i) receive, from the first remote server, an indication of a first alert that is triggered by a reading from the sensor that exceeds a first threshold; and
(ii) output and indication of the first alert; and
(e) a fifth software module that, after the authentication of the second login credentials and when executed by the processing unit of the mobile computing device, causes the mobile computing device to:
(i) receive, from the second remote server, an indication of a second alert that is triggered by at least one of (1) a reading from the sensor that exceeds a second threshold and (2) data descriptive of the first alert that exceeds the second threshold; and
(ii) output and indication of the second alert.

3. The application of claim 2, wherein the second software module, when executed by the processing unit of the mobile computing device, further causes the mobile computing device to:
transmit, to the first remote server, (1) an indication of an identifier of the wireless sensor and (2) an indication of an electronic communications address via which the first alert may be received.

4. The application of claim 2, wherein the third software module, when executed by the processing unit of the mobile computing device, further causes the mobile computing device to:
transmit, to the second remote server, an indication of an identifier of an insurance policy.

5. The application of claim 2, wherein indication of the first alert is output via a fourth graphical user interface comprising fourth interface features.

6. The application of claim 2, wherein indication of the second alert is output via a fifth graphical user interface comprising fifth interface features.

7. The application of claim 2, wherein the second alert is indicative of an adjustment to a monetary parameter of an insurance policy.
